(19) United States
(12) Patent Application Publication
(10) Pub. No.: US 2024/0139743 A1
(43) Pub. Date: May 2, 2024

(54) DIGITAL MICROFLUIDIC DEVICE WITH CAPACITIVE SENSING

(71) Applicant: NUCLERA LTD, Cambridge (GB)

(72) Inventors: Richard J. Paolini, Jr., Cambridge (GB); Seth Bishop, Cambridge (GB)

(21) Appl. No.: 18/281,226

(22) PCT Filed: Mar. 8, 2022
(86) PCT No.: PCT/GB2022/050603

§ 371 Date: Sep. 8, 2023

Related U.S. Application Data
(60) Provisional application No. 63/157,873, filed on Mar. 8, 2021.

(51) Int. Cl. B01L 3/00

(52) U.S. Cl. CPC B01L 3/502792; B01L 2200/0673; B01L 2300/0645; B01L 2300/0816; B01L 2300/165; B01L 2400/0427

(57) ABSTRACT

Disclosed are methods and devices for sensing the presence of aqueous droplets on digital microfluidic devices.

Disclosed are methods and devices for sensing the presence of aqueous droplets on digital microfluidic devices.

### BACKGROUND OF INVENTION

Digital microfluidic devices use independently controllable electrodes to propel, split, and join droplets in a confined environment, thereby providing a “lab-on-a-chip.” Digital microfluidic devices are alternatively referred to as electrowetting on dielectric, or “EWoD,” devices to differentiate them from competing microfluidic systems that rely on electrophoresis and/or micropumps. A 2012 review of electrowetting technology was provided by Wheeler in “Digital Microfluidics,” Annu. Rev. Anal. Chem. 2012, 5:413-40. The technique allows sample preparation, assays, and synthetic chemistry to be performed with tiny quantities of both samples and reagents. In recent years, controlled droplet manipulation in microfluidic cells using electrowetting has become commercially-viable; and there are now products available from large life science companies, such as Oxford Nanopore.

Most of the literature reports on EWoD involve so-called “segmented” devices, in which a limited number (typically ten to twenty) electrodes are directly driven by a controller. While segmented devices are easy to fabricate, the number of electrodes is limited by space and driving constraints. Accordingly, it is not possible to perform massive parallel assays, reactions, etc. in segmented devices.

In contrast, “active matrix” devices (a.k.a. active matrix EWoD, a.k.a. AM-EWoD) devices are known which can have many thousands, hundreds of thousands or even millions of addressable electrodes. These active matrix EWoD devices are conceptually similar to active matrix liquid crystal and electrophoretic displays and typically comprise a first substrate or backplane bearing a two dimensional array of first electrodes arranged in a plurality of rows and a plurality of columns. Each first electrode has an associated transistor, typically a thin-film transistor (TFT), with the first electrode connected to the drain of the transistor (this arrangement will be assumed herein, although it is essentially arbitrary and the first electrode could be connected to the source of the transistor. The sources of all the transistors in each column are connected to a single source line (also known as a column or data line), while the gates of all the transistors in each row are connected to a single row line. The various row lines are connected to a row driver, which essentially ensures that at any given moment only one row is selected, i.e., that there is applied to the selected row line a voltage such that all the transistors in the selected row are conductive, while there is applied to all other row lines a voltage which renders the transistors non-conductive. The various source lines are connected to a source driver, which places upon the source lines voltages required to drive the first electrodes in the selected row; since only the transistors in the selected row are conductive, the voltages on the source lines are transmitted only to the first electrodes in the selected row. After a pre-selected interval known as the “row address time” the selected row is deselected, the next row is selected, and the voltages on the source lines are changed to that the next line of the display is addressed. This process is repeated so that the entire device is addressed in a row-by-row manner.

An active matrix EWoD device further comprises a second or front substrate comprising at least one second electrode; typically there is only one second electrode which extends across the entire device. The first and second substrates are held parallel with a small cavity (“microfluidic region”) between them, and this cavity is typically filled with a first fluid, although it could be filled with a gas. When the device is operating, the cavity also contains droplets of a second fluid immiscible with the first; in practice, the second fluid is usually aqueous and the first non-aqueous, and typically an oil. As described below with reference to FIG. 1, by appropriate manipulation of the potentials of the first electrodes, it is possible to move the droplets laterally and to split and merge droplets. Thus, AM-EWoD devices can be used as general purpose devices that allow great freedom for controlling multiple droplets and executing simultaneous analytical processes.

One of the major challenges in operating AM-EWoD devices is detecting the positions of the droplets. For example, if a droplet is to be split in two, it is desirable to confirm that the original droplet is in proper position for splitting and to confirm the presence of the two droplets after splitting. While it might appear at first glance that this could readily be done optically, the small size of the droplets (of the order of 100 μm) and, in some cases, the lack of contrast between the droplet and the surrounding oil, may render optical confirmation difficult. Optical confirmation also requires a clear view of the droplets, which may for example be difficult if the device requires shielding because of the presence of toxic or hazardous biological materials. Accordingly, electrical detection of droplet position is generally preferred. U.S. Pat. No. 10,882,042 describes a process for detecting droplet position which relies upon a change in capacitance due to the difference in dielectric constant between the aqueous droplet and the surrounding oil. However, the process described requires the addition to the second substrate of a TFT array and the provision of a second set of drivers, both of which add considerable cost and complexity to the second substrate, and raise alignment issues since the TFT array in the second substrate must be accurately aligned with the first electrodes in the first substrate.

U.S. Pat. No. 8,653,832 describes an array element with writing circuitry and impedance measurement circuitry provided at each element of the array. This adds a great deal of cost and complexity to the device by adding complex circuitry at every element of the array, thus increasing substantially the fabrication cost in making the TFT and increasing driver cost for the large number of drivers needed to control the added circuits at each pixel times thousands of drive lines.

There is thus a need for improved methods of detecting the position of droplets in AM-EWoD devices without the need for substantial modifications of the second substrate or addition of additional circuitry at every pixel of a TFT array, and the present invention seeks to provide such methods and devices adapted to carry them out.

### SUMMARY OF INVENTION

Accordingly, this invention provides a digital microfluidic device, comprising:
a first substrate comprising a plurality of first electrodes each having a transistor associated therewith, the first substrate further comprising a plurality of source lines, each source line being connected to a plurality of the first electrodes via their associated transistors, and a first dielectric layer covering the first electrodes and their associated transistors;
a second substrate spaced from the first substrate and comprising at least one second electrode and a second dielectric layer covering the second electrode; and
means for introducing a fluid between the first and second substrates and creating a microfluidic region between the first and second substrates,
wherein at least one source line is provided with capacitance measuring means arranged to measure the capacitance between at least one of the first electrodes connected thereto and the at least one second electrode, and thereby determine the present or absence of a fluid droplet between said at least one of the first electrodes and the at least one second electrode.

This invention provides a digital microfluidic device, comprising:
a first substrate comprising a plurality of first electrodes each having a transistor associated therewith, the first substrate further comprising a plurality of source lines, each source line being connected to a plurality of the first electrodes via their associated transistors, and a first dielectric layer covering the first electrodes and their associated transistors;
a second substrate spaced from the first substrate and comprising at least one second electrode and a second dielectric layer covering the second electrode; and
a microfluidic region between the first and second substrates,
wherein at least one source line is arranged to measure the capacitance between at least one of the first electrodes connected thereto and the at least one second electrode, and thereby determine the presence or absence of a fluid droplet between said first electrodes and the at least one second electrode.

The digital microfluidic device of the present invention may further comprise means for applying an alternating voltage to the at least one second electrode. The microfluidic region between the first and second substrates may be filled with a first fluid and the fluid introduction means arranged to introduce a second fluid immiscible with the first fluid. Typically, one fluid is aqueous and the other non-aqueous; in some embodiment of the invention, the second fluid is aqueous and first fluid is non-aqueous. Each of the first and second dielectric layers may itself be hydrophobic, or it may have a hydrophobic layer superposed thereon. The capacitance measuring means may comprise a capacitor connected to one source line and means for measuring the voltage drop across the capacitor. One or more of the source lines may contain a capacitor. Each source line may contain a capacitor.

The present invention also provides a method of determining the presence or absence of a droplet adjacent a specific first electrode in a digital microfluidic device, the device comprising:
a first substrate comprising a plurality of first electrodes each having a transistor associated therewith, the first substrate further comprising a plurality of source lines, each source line being connected to a plurality of the first electrodes via their associated transistors, and a first dielectric layer covering the first electrodes and their associated transistors;
a second substrate spaced from the first substrate and comprising at least one second electrode and a second dielectric layer covering the second electrode; and
means for introducing a fluid between the first and second substrates and creating a microfluidic region between the first and second substrates,
the method comprising measuring the capacitance between said specific first electrode and the at least one second electrode.

The present invention also provides a method of determining the presence or absence of a droplet adjacent a specific first electrode in a digital microfluidic device, the device comprising:
a first substrate comprising a plurality of first electrodes each having a transistor associated therewith, the first substrate further comprising a plurality of source lines, each source line being connected to a plurality of the first electrodes via their associated transistors, and a first dielectric layer covering the first electrodes and their associated transistors;
a second substrate spaced from the first substrate and comprising at least one second electrode and a second dielectric layer covering the second electrode; and
a microfluidic region between the first and second substrates,
the method comprising measuring the capacitance between said specific first electrode and the at least one second electrode.

In these methods and devices, the measurement of the capacitance between said specific first electrode and the at least one second electrode may be effected by applying an alternating voltage to the at least one second electrode, connecting a capacitor to said specific first electrode and measuring the voltage drop across the capacitor. Where, as is typically the case, the plurality of source lines are arranged parallel to one another, the method may further comprise driving the two source lines closest to the source line connected to the specific first electrode at the same voltage as the source line connected to the specific first electrode.

### BRIEF DESCRIPTION OF DRAWINGS

FIG. 1 of the accompanying drawings is a schematic top plan view of a typical prior art EWoD device.

FIG. 2 is a schematic cross-section through a portion of the EWoD device shown in FIG. 1, and illustrates the manner in which droplets are moved within the device.

FIG. 3 is a schematic circuit diagram of a portion of the EWoD device shown in FIG. 1 and illustrates the manner in which the potentials of the various pixel electrodes of the device are applied and maintained.

FIG. 4 is a schematic circuit diagram of an EWoD device of the present invention.

FIG. 5 is a schematic circuit diagram of a source driver which may be substituted for that in the EWoD device shown in FIG. 4.

FIG. 6 is a schematic circuit diagram of the capacitance measuring means of one source line of the source driver shown in FIG. 5 and it associated pixel electrode.

FIG. 7 is a schematic circuit diagram of a further EWoD device of the present invention with a capacitance measuring means differing from that shown in FIG. 6.

FIG. 8 is a schematic circuit diagram of a modified version of the capacitance measuring means of FIG. 6, the modification serving to reduce the number of analog digital convertors required in the EWoD device.

FIGS. 9, 10 and 11 are schematic circuit diagrams of further EWoD devices of the present invention with capacitance measuring means differing from those shown in FIGS. 6 and 7.

### DETAILED DESCRIPTION

As indicated above, the present invention provides a digital microfluidic (EWoD) device in which at least one source line is provided with capacitance measuring means arranged to measure the capacitance between at least one of the first (or pixel) electrodes connected to the source line and the second (or common) electrode, and thereby determine the presence or absence of a fluid droplet between this pixel electrode or electrodes and the common electrode.

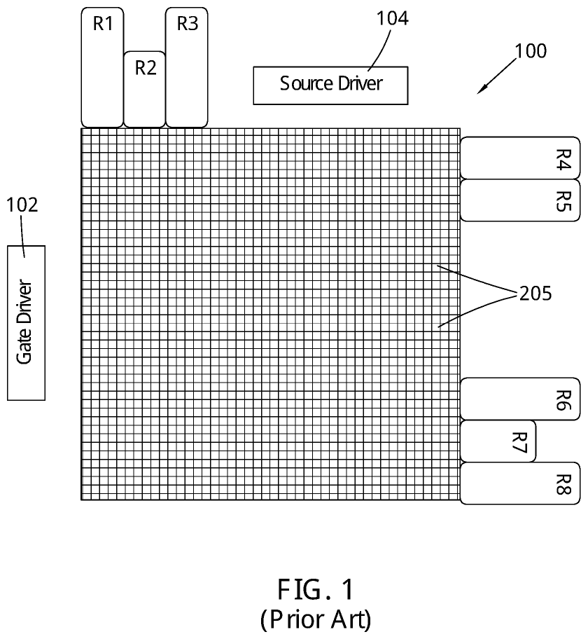

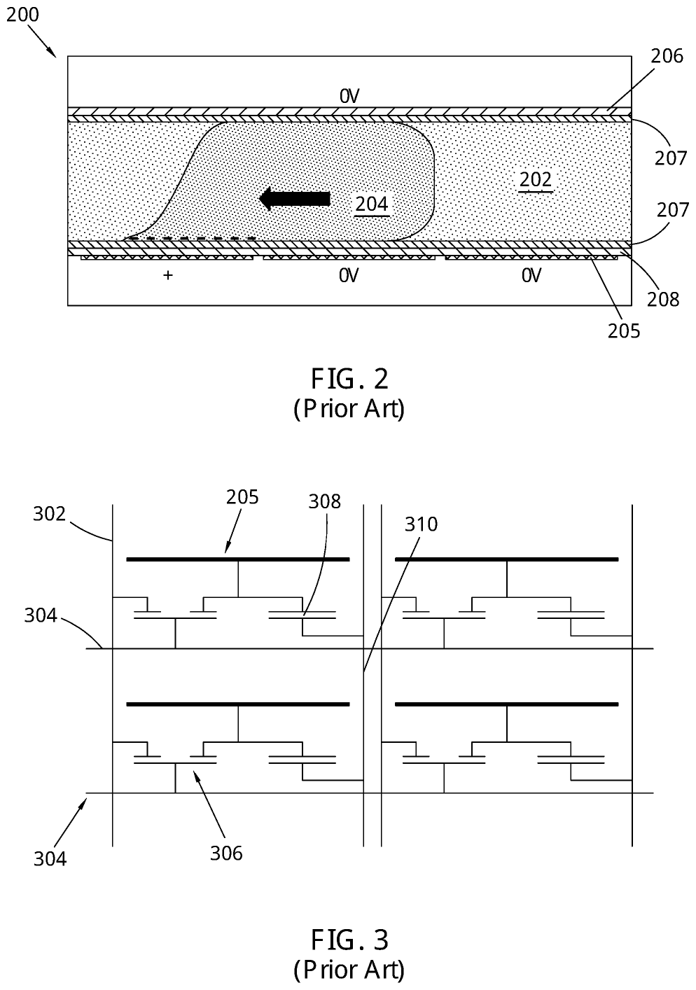

The basic structure of an EWoD device will first be described with reference to FIGS. 1-3. As shown in FIG. 1, the general architecture of an EWoD device (generally designated 100) is similar to that of an active matrix electro-optic display, with a planar rectangular matrix of first or pixel electrodes 205 which lie parallel to but spaced from a single second or common electrode 206 (not shown in FIG. 1, and best seen in FIG. 2). Around the periphery of the matrix of pixel electrodes 205 are arranged reservoirs R1-R7, which are arranged to introduce droplets 204 (FIG. 2) between the pixel electrodes 205 and the common electrode 206. Depending upon the intended application of the EWoD device, the reservoirs R1-R7 may contain biological specimens (for example body fluids), reagents, raw materials, catalysts, solvents and cosolvents or any other materials required for the chemical reactions or tests to be conducted by the device. In FIG. 1, the reservoirs R1-R7 are shown arranged in three groups along two different edges of the matrix of electrodes 205 but this is purely for purposes of illustration and the number of reservoirs, their grouping and their placements may be varied as desired.

In one example embodiment, a sample droplet to be assayed for the presence and optionally the concentration of an analyte to is diluted by combination with one or more droplets of a solvent, and the dilution step may be repeated until a desired analyte concentration range is attained. Then, a droplet of the diluted sample is mixed with droplet(s) of one or more reactants that form a detectable, quantifiable assay product with the analyte. Thereafter, the sample droplets may be transferred to other locations for detecting and measuring the concentration of the assay product. Example detection and measuring techniques include spectrophotometry in the visible, UV, and IR ranges, time-resolved spectroscopy, fluorescence spectroscopy, Raman spectroscopy, phosphorescence spectroscopy, and potentiodynamic electrochemical measurements such as cyclic voltammetry (CV). In instances where the analyte is a diagnostic biomarker, for example a protein associated with a given disease or disorder, the sample droplet may be mixed with a droplet of a solution containing an antibody directed against the protein to be measured. In an enzyme-linked immunosorbent assay (ELISA), the antibody is linked to an enzyme, and another droplet, this time of a substance containing the enzyme's substrate, is added. The subsequent reaction produces a detectable signal, most commonly a color change that may be detected and measured. To enable the aforementioned types of spectroscopic analysis (including color measurement) to be effected, the common electrode 206 is typically radiation transmissive, and may be formed from, for example indium tin oxide. Obviously, the radiation transmissive properties of the common electrode 206 need to be chosen having regard to the wavelengths at which the spectroscopic analysis is to be conducted. In one embodiment, the common electrode includes a light-transmissive region, for example 10 mm² in area, to enable visual or spectrophotometric monitoring of fluid droplets inside the device (not shown).

The device 100 further comprises a gate (or row) driver 102 and a source (or data) driver 104, both of which function in a manner similar to the corresponding drivers of an active matrix electro-optic display, as discussed below with reference to FIG. 3. The connections between the drivers 102 and 104 and the pixel electrodes 205 are omitted from FIG. 1 for ease of illustration.

As shown in FIG. 2, the gap between the pixel electrodes 205 and the common electrode 206 is filled with a layer of oil (or other hydrophobic fluid) 202, within which is contained at least one aqueous droplet 204, originally dispensed from one of the reservoirs R1-R7 (FIG. 1). The use of aqueous drops in a water-immiscible matrix is conventional in EWoD devices because most reactions of interest are carried out in aqueous media. However, it will be appreciated that EWoD devices could use water-immiscible drops in an aqueous matrix, or indeed any combination of two immiscible fluids differing in dielectric constant (to permit driving of the droplets as described below). The cell gap between the electrodes 205 and 206 is typically in the range 50 to 200 μm, but the gap can be larger or smaller. FIG. 2 illustrates three adjacent pixel electrodes (also referred to as “propulsion electrodes”) 205 and a portion of the common electrode 206. Hydrophobic coatings 207 are provided overlying the electrodes 205 and 206 and in contact with the oil layer 202. A dielectric layer 208 is interposed between the electrodes 205 and the adjacent hydrophobic coating 207. (Although not shown in FIG. 2, a dielectric coating may also be interposed between the common electrode 206 and its adjacent hydrophobic coating 207.) While theoretically a single layer could serve for both the dielectric and hydrophobic functions, such layers typically require thick inorganic layers (to prevent pinholes) with resulting low dielectric constants, thereby requiring more than 100V for droplet movement. To achieve low voltage actuation, it is usually better to have a thin, pinhole-free inorganic layer for high capacitance, topped by a thin organic hydrophobic layer. With this combination it is possible to have electrowetting operation with voltages in the range ±10 to ±50V, which is in the range that can be supplied by conventional TFT arrays.

The dielectric layer 208 should be thin enough and have a dielectric constant compatible with low voltage AC driving, such as available from conventional image controllers for LCD displays. For example, the dielectric layer may comprise a layer of approximately 20-40 nm silica topped over-coated with 200-400 nm plasma-deposited silicon nitride. Alternatively, the dielectric layer may comprise atomic-layer-deposited alumina between 5 and 500 nm thick, preferably between 150 and 350 nm thick.

The hydrophobic coatings 207 can be constructed from one or a blend of fluoropolymers, such as PTFE (polytetrafluoroethylene), FEP (fluorinated ethylene propylene), PVF (polyvinylfluoride), PVDF (polyvinylidene fluoride), PCTFE (polychlorotrifluoroethylene), PFA (perfluoroalkoxy polymer), FEP (fluorinated ethylene-propylene), ETFE (polyethylenetetrafluoroethylene), and ECTFE (polyethylenechlorotrifluoroethylene). Commercially available fluoropolymers Teflon AF (Sigma-Aldrich, Milwaukee, WI; “Teflon is a Registered Trade mark) and FluoroPel™ coatings from Cytonix (Beltsville, MD), which can be spin coated over the dielectric layer 208. An advantage of fluoropolymer films is that they can be highly inert and can remain hydrophobic even after exposure to oxidizing treatments such as corona treatment and plasma oxidation. Coatings having higher contact angles may be fabricated from one or more superhydrophobic materials. Contact angles on superhydrophobic materials typically exceed 150°, meaning that only a small percentage of a droplet base is in contact with the surface. This imparts an almost spherical shape to the water droplet. Certain fluorinated silanes, perfluoroalkyls, perfluoropolyethers and RF plasma-formed superhydrophobic materials have found use as coating layers in electrowetting applications and render it relatively easier to slide along the surface. Some types of composite materials are characterized by chemically heterogeneous surfaces where one component provides roughness and the other provides low surface energy so as to produce a coating with superhydrophobic characteristics. Biomimetic superhydrophobic coatings rely on a delicate micro or nano structure for their repellence, but care should be taken as such structures tend to be easily damaged by abrasion or cleaning.

The hydrophobic coating 207 prevents the droplet from wetting the surface. When no electric field is applied to the droplet, it will maintain a spheroidal shape to minimize contact with the hydrophobic surfaces of the oil and hydrophobic layers. Because the droplets do not wet the hydrophobic surfaces, they are less likely to contaminate the surfaces or interact with other droplets except when that behavior is desired. Accordingly, individual aqueous droplets can be manipulated about the array of pixel electrodes, and mixed, split, combined, as known in the field.

However, as illustrated in FIG. 2, when a voltage differential is applied between adjacent pixel electrodes 205, the voltage on one electrode attracts opposite charges in the droplet 204 at the dielectric-to-droplet interface, and the droplet moves toward this electrode, as indicated by the arrow in FIG. 2. The voltages needed for acceptable droplet propulsion depend on the properties of the dielectric and hydrophobic layers. AC driving is normally used to reduce degradation of the droplets, dielectrics, and electrodes by various electrochemical reactions. Operational frequencies for EWoD device can be in the range 100 Hz to 1 MHz, but frequencies of 1 kHz or lower are preferred for use with TFTs that have limited speeds of operation.

As shown in FIG. 2, the common electrode 206 is a single conducting layer normally set to zero volts or a common voltage value (VCOM) close to zero to take into account offset voltages on the electrodes 205 due to capacitive kickback or gate voltage drop from the TFTs that are used to switch the voltage on the electrodes (as discussed below with reference to FIG. 3). Any references to “top” and “bottom” herein are merely a convention as the locations of the two electrodes can be switched, and the device can be oriented in a variety of ways, for example, the top and bottom electrode can be roughly parallel while the overall device is oriented so that the substrates are normal to a work surface. The top electrode can also have a square wave applied to increase the voltage across the liquid. Such an arrangement allows lower propulsion voltages to be used for the TFT connected propulsion electrodes 205 because the top plate voltage 206 is additional to the voltage supplied by the TFT.

FIG. 3 is a schematic circuit diagram showing the manner in which the pixel electrodes 205 are driven. The drive circuitry shown in FIG. 3 is of active matrix type and operates similarly to an active matrix electro-optic display. Each pixel electrode 205 is connected to the drain of an associated transistor 306, the source of which is connected to a data or source line 302, with the sources of all transistors 306 in one column of the matrix being connected to the same source line. The gate of transistor 306 is connected to a gate or select line 304, with the gates of all transistors 306 in one row of the display being connected to the same select line. The drain of the transistor 306 is also connected to one electrode of a capacitor 308, the other electrode of which is connected to a capacitor line 310, the lower electrodes (as illustrated in FIG. 3) of all capacitors in one column of the display being connected to the same capacitor line 310. (The capacitors 308 serve to present crosstalk from parasitic capacitances, such as those discussed below) Alternatively, the capacitor lines 310 may be eliminated and the lower electrodes of capacitors 308 connected to a select line adjacent to that to which its associated transistor 306 is connected. All the select lines 304 are connected to the gate driver 102 (FIG. 1), while all the source lines 302 are connected to the source driver 104 (FIG. 1). The capacitor lines 310 are maintained at the same potential as the common electrode 206.

As in a conventional active matrix electro-optic display, the source driver 104 places upon the source lines 302 the voltages to be transferred to one row of propulsion electrodes 205 for electrowetting operation. The gate driver 102 then applies to one gate line 304 a voltage which causes the gates of all transistors in the row to open, thereby transferring the voltages from the sources lines 302 to the propulsion electrodes 205 in the selected row. These steps are repeated so that the device is scanned by line-at-a time addressing, If no movement is needed, or if a droplet is meant to move away from a propulsion electrode, then 0V will be applied to that (non-target) propulsion electrode. If a droplet is meant to move toward a propulsion electrode, an AC voltage will be applied to that (target) propulsion electrode.

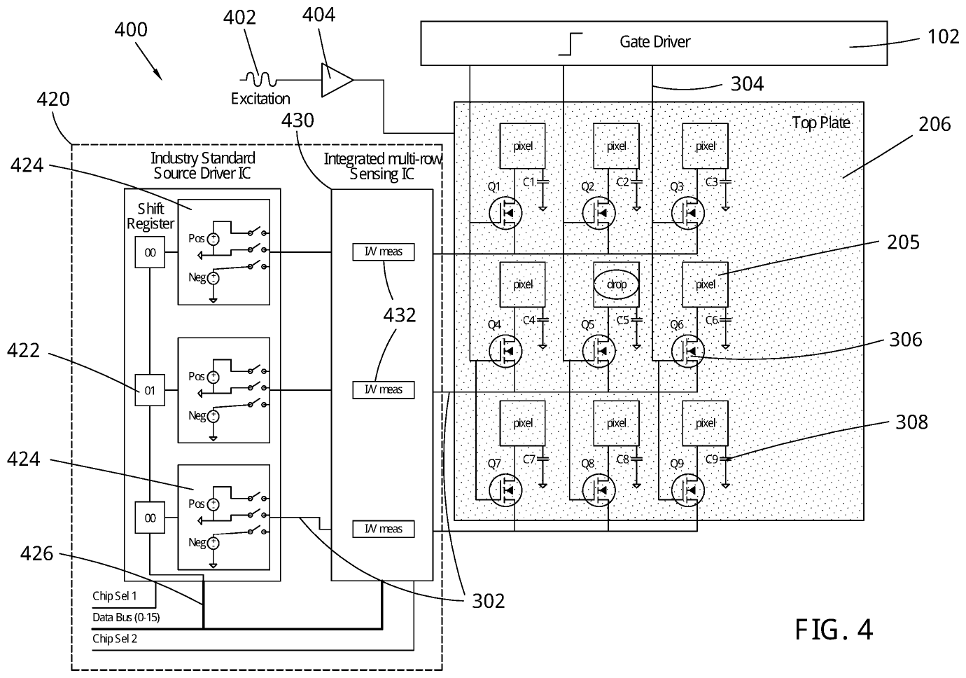

FIG. 4 is a schematic circuit diagram of an EWoD device (generally designated 400) of the present invention. The common electrode 206, the pixel electrodes 205, the transistors 306, the capacitors 308 and the gate driver 102 are all essentially identical to the corresponding parts of the devices shown in FIGS. 1-3, and hence will not be described in detail. The common electrode 206 and the pixel electrodes 205 are provided with hydrophobic and dielectric layers similar to those shown in FIG. 2, but these layers are omitted from FIG. 4 and later Figures for ease of illustration. (Note that FIG. 4 shows the device 400 rotated 90° as compared with the device shown in FIG. 1, so that in FIG. 4 the select lines are shown vertical and the source lines horizontal.) Although FIG. 4 illustrates only three gate lines 304 and three source lines 302, in practice a substantially large number, perhaps 200, of each would be used. An on/off switchable AC excitation voltage indicated at 402 is fed via an amplifier 404 to the common electrode 206.

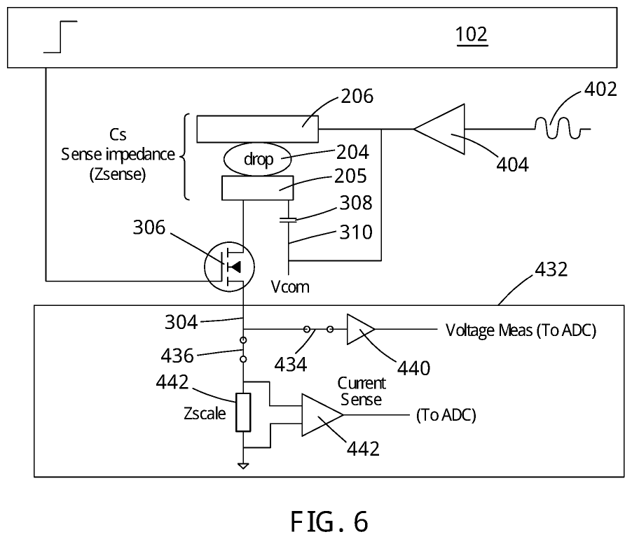

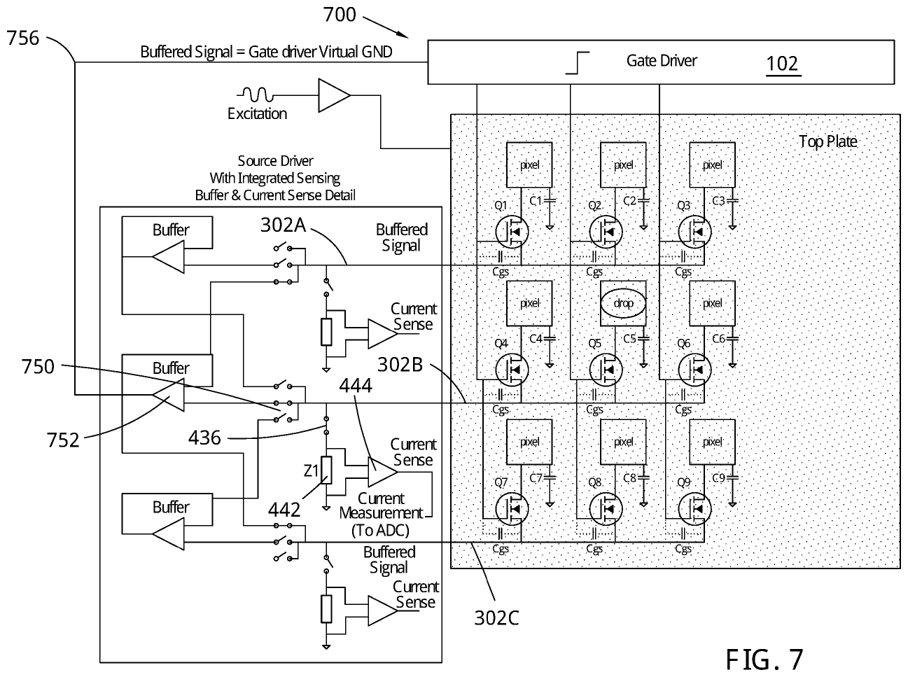

The source driver of the device 400 differs significantly from that shown in FIG. 1 and comprises all the circuitry within the dashed box 420. The first part of the source driver, comprising a shift register 422 and a series of switches 424 (one switch 424 being associated with each source line 302) form a conventional tri-level source driver of a type which is familiar to anyone skilled in electro-optic display technology. Under the control of a clock signal (not shown in FIG. 4), data is received serially on a data bus 426 and is latched by means of the shift register 422, thereby causing each source line 302 to be connected by its associated switch 424 to one of three inputs delivering voltages of −V, 0 and +V, where V is the operating voltage of the pixel electrodes 205. In a conventional source driver, the source lines 302 emerging from the switches 424 would be connected directly to the sources of the transistors 306. However, in the device 400 shown in FIG. 4, the source lines 302 first pass through a capacitance measuring assembly 430 having one capacitance measuring circuit 432 associated with each source line 302. As described below, with reference to FIG. 6, the function of the capacitance measuring circuits 432 is to measure the capacitance associated with each of the pixel electrodes connected to the circuit 432 via the transistors 306.

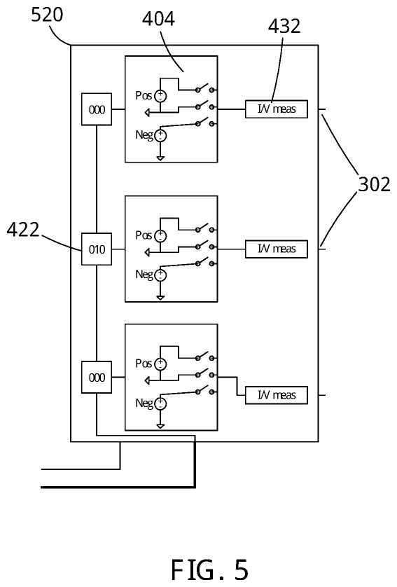

The device 400 shown in FIG. 4 is designed to reduce to a minimum the amount of custom circuitry which must be fabricated; since the shift register 422 and switches 424 are conventional (and available commercially as an integrated circuit), only capacitance measuring assembly 430 need be custom fabricated. However, the device 400 does require providing one connection between the switches 424 and the capacitance measuring assembly 430 for each source line 302, and the resultant large number of wired connections may introduce reliability problems. Accordingly, if the number of units to be manufactured justify the custom fabrication costs, the source driver 420 shown in FIG. 4 may be replaced by the single chip source driver 520 shown in FIG. 5. In source driver 520, the shift register 422, the switches 424 and the capacitance measuring circuits 432 are all provided on a single chip, thus eliminating a large number of wired connections and also reducing the number of external control signal connections required to the source driver.

The manner in which the capacitance measuring circuits 432 measure the capacitance of all pixel electrodes to which they can be connected by the transistors 306 will now be described with reference to FIG. 6. However, it should first be understood that since the device and method of the present invention uses the same set of source lines both for driving the display and for measuring capacitance, the device necessarily has a driving mode and a measuring mode, and can only operate in one mode at any one time. The relative amounts of time which the device spends in its driving and measuring modes can vary widely depending primarily upon the use of the device. For example, when a protocol for a new reaction or test is being developed, it may be desirable to place the device in measuring mode after every generation, movement or splitting or a droplet, or combination of two or more droplets, in order to check that everything is proceeding as planned. It has been found that capacitance measurement during the measuring mode can be sufficiently rapid that operation of the EWoD device is not unduly slowed. On the other hand, when the device is being used to carry out a large number of repetitions of a routine test according to a well-established protocol, a large number of droplet movements may be carried out successively using the driving mode, with the measurement mode only being used at comparatively long intervals to confirm certain crucial steps.

The driving mode of the device 400 shown in FIG. 4 functions in a manner essentially the same as prior art EWoD devices. The excitation voltage 402 is switched off, and droplet movement is effected as previously described with reference to FIG. 2 with the matrix of pixel electrodes 205 being scanned in the conventional row-by-row manner. (The present invention does not exclude the possibility that during the driving mode, the potential of the common electrode 206 might be varied by means other than the excitation voltage 402 as known in the art to increase the driving voltage across the display.)

The measuring mode of the device 400 shown in FIG. 4 will now be described with reference to FIG. 6. As already mentioned, the function of the measuring mode is to determine the location of droplets 204 on the matrix of pixel electrodes 205 or, in other words, to determine whether or not a droplet 204 is present between any specific pixel electrode 205 and the adjacent portion of the common electrode 206. As is readily apparent from FIG. 6, each pixel electrode and the common electrode form a parallel plate capacitor, the capacitance of which depends upon the dielectric constant of the material present between the two electrodes. As previously noted, typically an EWoD device manipulates aqueous droplets comprising solutions of many different chemistries, such as surfactants, salts, enzymes, proteins, DNA and other solutes. Accordingly, if such an aqueous droplet is present between a specific pixel electrode and the common electrode, the dielectric constant between the electrodes will be that of the aqueous droplet, which will be close to that of water (about 80 at room temperature). If no droplet is present adjacent a specific pixel electrode, the dielectric constant between the electrodes will be that the oil or other non-aqueous fluid used, which will typically be not more than about 5. With 200 μm square pixels and assuming a spacing of about 50 μm between the common and pixel electrodes, the capacitance will be about 0.2 picofarad (pF) with a droplet of water between the electrodes and about 0.01 pF with oil between the electrodes. Accordingly, there will be a difference of about an order of magnitude in the capacitance depending upon whether or not an aqueous droplet is present adjacent the specific pixel electrode, and conversely a difference of the order of magnitude of the impedance of the capacitance between the two cases. (These differences will still occur if the EWoD device manipulates non-aqueous droplets in an aqueous medium, although of course the differences would be reversed, with the aqueous medium showing the higher capacitance and lower impedance in the absence of the non-aqueous droplet.) This difference in capacitance is more than sufficient to enable the presence or absence of aqueous droplets to be detected using the circuitry described below.

As shown in FIG. 6, the capacitor formed by the pixel electrode and the common electrode has a capacitance designated by “Cs” and an impedance designated by “Zsense”. In the measuring mode illustrated in FIG. 6, an excitation voltage Vex is applied to the common electrode 206 via amplifier 404; the excitation voltage, which may be periodic or sinusoidal, should be small enough as not the disturb any droplets adjacent the pixel electrodes. The excitation voltage Vex is also supplied from amplifier 404 via line 310 to one plate of the capacitor 308. The source of transistor 306 is connected, within capacitance measuring circuit 432, via a closed switch 434 to the input of a high impedance sensing amplifier 440, the output of which is fed to an analog-to-digital convertor (“ADC”—not shown in FIG. 6). The voltage at the input of amplifier 432 is denoted “Vsense” and the amplifier 432 simply serves to scale this voltage to the range of the ADC, typically 0-5 V. The source of transistor 306 is also connected via a closed switch 436 to a capacitor 442 have a capacitance designated “Zscale”, the other side of the capacitor 436 being connected to ground. (If desired, a resistor may be substituted for the capacitor 442, since the function of the capacitor is simply to provide an known impedance in a half bridge, as discussed below.) The switches 434 and 436 are closed when the device is in its measuring mode but open when the device is in its driving mode in order to prevent the capacitance measuring circuit 432 interfering with the driving mode. The switches 434 and 436 could be replaced by a single switch if desired. The plates of the capacitor 442 are also connected to the inputs of a current sensing amplifier 444, the output of which is fed to an analog-to-digital convertor (not shown in FIG. 6). The amplifier 444 measures the alternating current flowing through the pixel electrode to ensure that it is low enough not to disturb any droplet present. It is not necessary that every source line be provided with an amplifier 444.

During the measuring mode of device 400, the gate driver 102 scans the rows of pixel electrodes in the same manner as during the driving mode (although the rate of scanning may differ between the two modes) so that only one row of transistors 306 are conductive at any one time. Hence, only one pixel electrode 205 is connected to its associated capacitance measuring circuit 432 at any one time. The capacitor formed by the pixel electrode 205, the droplet 204 (or oil medium) and the common electrode 206, and the capacitor 442 form a half bridge or capacitive divider. By elementary principles:

Vsense=Vex·Zscale·(Zsense+Zscale)⁻¹

For accurate measurements of Zsense, and thus of Cs, Zscale needs to be of the same order of magnitude as Zsense.

From the foregoing equation, it will be seen that in principle Zsense can be calculated using only the voltage measured by amplifier 440 or only the current sensed by amplifier 444. However, in practice it is strongly preferred that both amplifiers be present, since it is often desirable to know the phase angle and/or timing difference between the voltage and current of the signal, and having the two independent measurements from the separate amplifiers allows for this. Having both amplifiers also alleviates the problem of needing to know what the exact sense impedance is in the circuit.

It will be noted that the foregoing equation also fails to take account of the drain-source impedance of the transistor 306, which is in series with Zsense and Zscale. The effect of this drain-source impedance is to reduce the sensitivity of the device in detecting the presence of a droplet between the pixel electrode and the common electrode, but the effect is most unlikely to affect droplet detection. The situation is further complicated by the tendency for the impedance of TFT's to change with time (over hundreds of operating hours), especially if the transistors are operated at a high percentage duty cycle, as in an adaptive gate driving configuration. If desired, a small sample of TFT's could be provided with impedance measuring circuits to provide an average drain-source impedance value, and the calculation of Zsense modified accordingly.

However, in practice matters are not so simple. The measure Zsense accurately, it is necessary to eliminate all capacitances other than Zscale from the active sensing source line. Stray capacitances which affect the measurement of Zsense include (i) capacitances between the source line being sensed and the two adjacent parallel source lines; and (ii) gate-source capacitances for all the non-conducting transistors on the active sensing source line (although the gate-source capacitance for any individual transistor is very small, the combined effect of (typically) several hundred non-conducting transistors on the active sensing source line is by no means negligible.

FIG. 7 illustrates an EWoD device (generally designated 700) similar to the device 400 shown in FIG. 4 but modified to eliminate the effects of source line-source line capacitance. The amplifiers 440 are omitted from FIG. 7 for ease of illustration. As shown in FIG. 7, each source line is, in addition to the connections previously described, connected to a triple switch assembly 750. If the source line is one on which capacitance measurements are currently being made (source line 302B in FIG. 7), the center switch of switch assembly 750 is closed and the two outer switches open, thus connecting source line 302 to one input of a buffer amplifier 752. The output of amplifier 752 is fed to (i) its own second input; (ii) via line 756 as a virtual ground signal to gate driver 102; and (iii) to adjacent source lines 302A and 302C via appropriate closed outer switches of their switch assemblies 750. Note that the amplifiers 752 associated with source lines 302A and 302C are disconnected from their source lines, so that the voltages of sources lines 302A and 302C are controlled only by the amplifier 752 associated with source line 302B. Sources lines 302A and 302C are thereby maintained at the same voltage as source line 302B, thus eliminating any source line-source line capacitance between source line 302B being sensed and the adjacent parallel source lines 302A and 302C.

In device 700 shown in FIG. 7, only one-third of the pixel electrodes in the selected row can have their capacitances measured at any one time; in a typical display having several hundred sources lines, the pattern of sources lines 302A, 302B, 302C would be repeated in each group of three adjacent sources lines, and only the pixels connected to sources lines 302B would have their capacitances measured. Note that in FIG. 7 the switch 436 provided between each source line and its associated capacitor (or resistor) 442 is closed only for the source line 302B, the switches for sources lines 302A and 302C being left open so prevent unwanted changes in the voltages on the source lines 302A and 302C. After the measurement of capacitance on source line 302B has been concluded, the positions of the switch assemblies 750 are changed, so that the capacitance of source line 302C can be measured, then finally that of source line 302A. Since three separate capacitance measurements have to be made on each row of pixels, it may be desirable to use a slower scan rate in the measuring mode than in the driving mode of the device.

The device 700 shown in FIG. 7 also allows for reduction or elimination of the effects of gate-source capacitance in the non-conducting transistors. As already noted, the output from amplifier 752 is fed via line 756 as a gate driver virtual ground to the gate driver 102. This virtual ground is then applied to the gates of all transistors other than those in the selected row, and thereby placing the gates of the non-conducting transistors connected to source line 302B at the same voltage as the sources of the same transistors, and thereby eliminating the effects of gate-source capacitance in these non-conducting transistors. Adding a virtual ground to a gate driver integrated circuit does add some complexity when making a digital data connection. Some level shifting, or isolation circuit should be added to the gate driver 102, to allow its ground signal to be driven by the buffer amplifier 752, as illustrated in FIG. 7.

The sensing amplifiers 440 and 444 (FIG. 6) and the buffer amplifiers 752 (FIG. 7) should have low parasitic current and high bandwidth, in order to take measurements at the preferred frequencies, which are of the order of 100 kilohertz, and to not disrupt the capacitance measurement with parasitic currents.

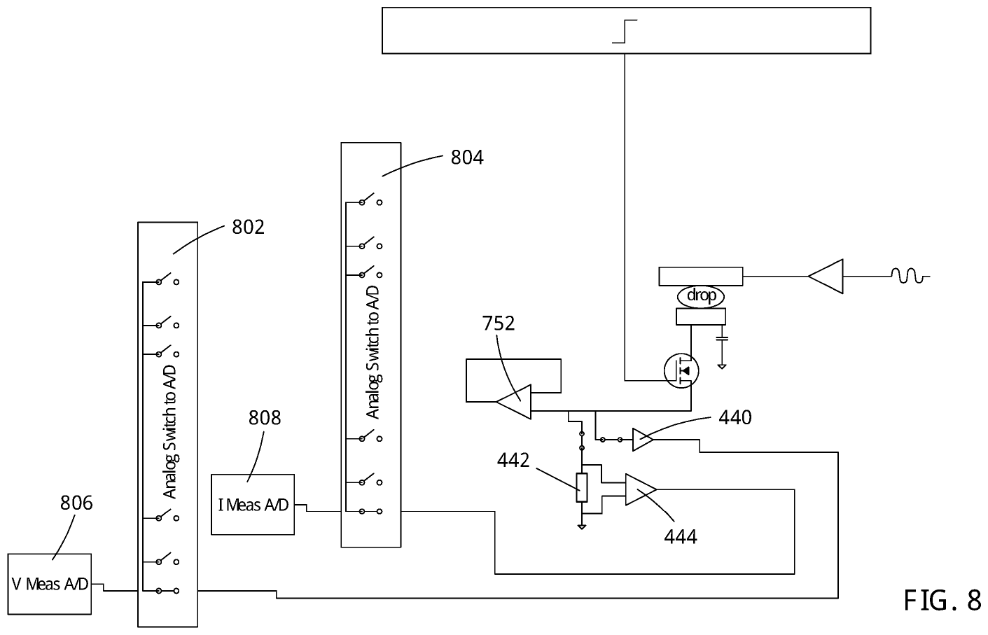

One problem with the devices shown in FIGS. 6 and 7 is that they require two separate ADC's for each source line, and thus 400 ADC's for a typical 200 column display. The number of ADC's can usefully be reduced by connecting the outputs of multiple amplifiers to a single ADC, as illustrated in FIG. 8, in which the output from amplifier 440 is fed to one input of an analog switch 802 and the output from amplifier 444 is fed to one input of an analog switch 804, it being understood that other amplifiers 440 and 444 are connected to other inputs of switches 802 and 804. The outputs from switches 802 and 804 are fed to single ADC's 806 and 808 respectively.

It will be apparent to those skilled in circuit design that the number of components required by a device of the present invention could be further reduced by multiplexing “upstream” of the amplifiers 440 and 444 rather than “downstream” of these amplifiers, as shown in FIG. 8, or in other words by interposing the analog switches between the source line and the amplifier 440 and between the capacitor 442 and the amplifier 444, thus permitting a single set of amplifiers 440 and 444 to service multiple source lines. However, the resulting saving in the cost of the amplifiers must be balanced against the resultant loss of speed and possible loss of accuracy.

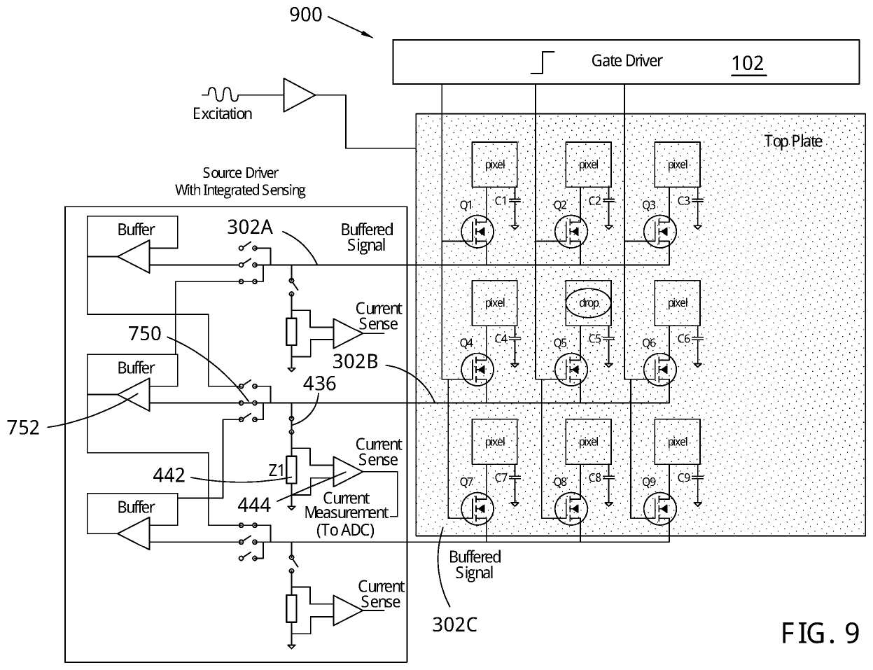

FIG. 9 shows a device (generally designated 900) which is similar to the device 700 shown in FIG. 7 but which lacks the line 756 connecting the buffer amplifier 752 to the gate driver 102. The device 900 operates in a manner very similar to the device 700 and thus effectively eliminates errors due to source line-source line capacitance, but does not deal with the effect of gate-source capacitance in the non-conducting transistors of the source line being sensed. The device 900 may thus be useful when gate-source capacitance in the non-conducting transistors is not a major problem, since the device 900 does not require modification of the conventional gate driver 102.

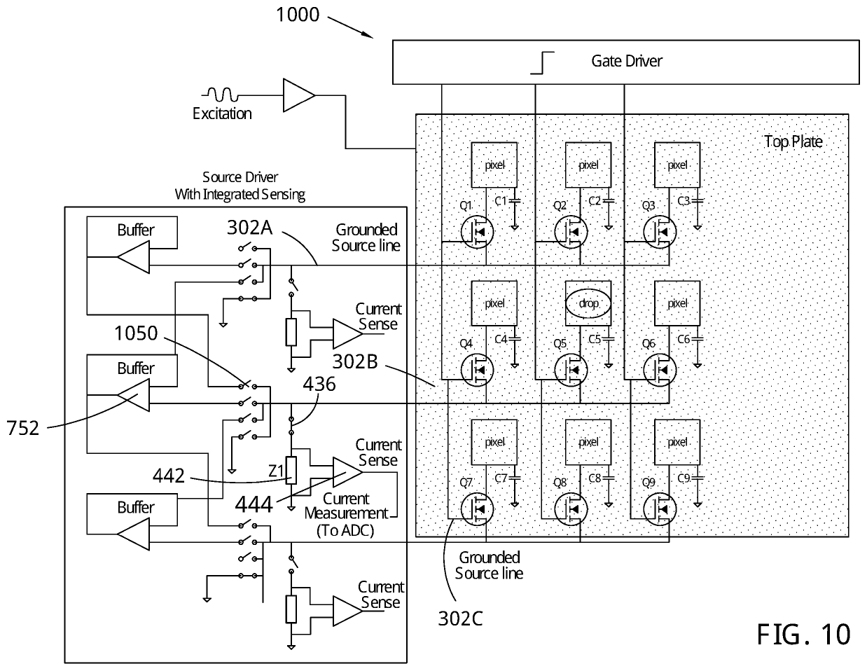

FIG. 10 shows a device (generally designated 1000) which is similar to the device 900 shown in FIG. 9 but in which the triple switches 750 shown in FIG. 9 are replaced by quadruple switches 1050, with the fourth switch connecting the associated source line to ground. The device 1000 operates in a manner similar to that of the device 900, with the sensed source line 302B connected via the switch 754 to the capacitor 442 and amplifier 444. However, instead of being maintained at the same voltage as the source line 302B, the adjacent source lines 302A and 302C are connected to ground via the switches 1050. Connecting the adjacent source lines to ground in this manner reduces the sensitivity of device 1000 as compared with device 900, since the sensitivity or scaling is changed by the parasitic capacitance between the sensed source line 302B on the one hand and the grounded adjacent source lines 302A and 302C on the other. However, the device 1000 is still considerably more accurate than it would be if the adjacent source lines 302A and 302C were simply allowed to float at high impedance.

In the mode of operation shown in FIG. 10, with the adjacent source lines 302A and 302C grounded, the buffer amplifiers 752 are of course superfluous. However, these amplifiers, and the parts of switches 1050 which can connect the output of one buffer amplifier 752 to the adjacent source lines, are provided so that the device 1000 can operate either with the adjacent source lines 302A and 302C grounded, or in the same manner as the device 900, with the adjacent source lines 302A and 302C held at the same voltage as the sensed source line 302B.

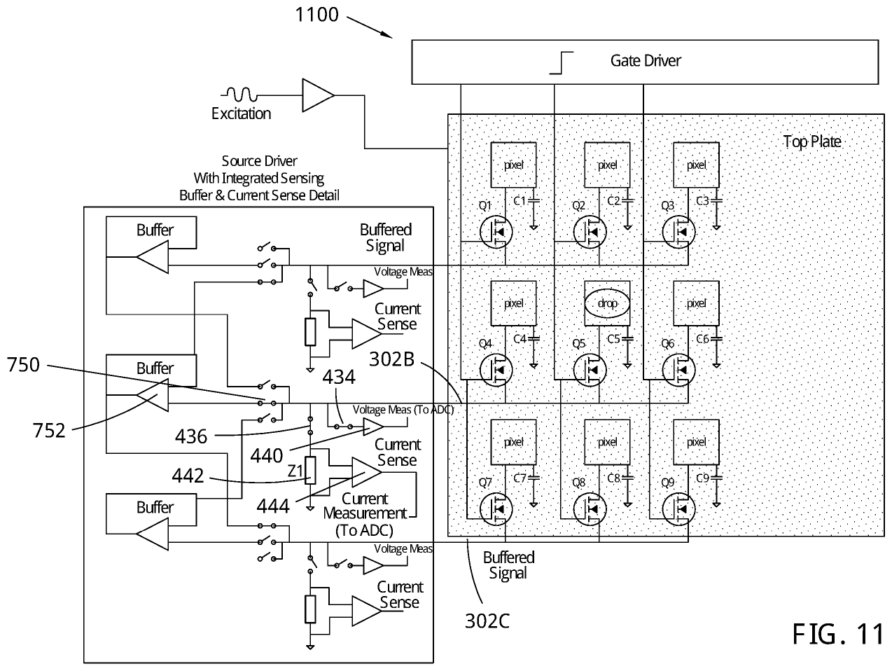

Finally, FIG. 11 shows a device (generally designated 1100) which is again similar to the device 900 shown in FIG. 9 but in which each source line is provided with both a current sensing amplifier 444 and a voltage sensing amplifier 440, both of which operate in the same manner as described above with reference to FIG. 6.

From the foregoing, it, will be seen that the present invention can provide apparatus and methods for detecting the position of droplets in EWoD devices without the need for substantial modifications of the second substrate or addition of additional circuitry at every pixel of a TFT array. The present invention allows for the use of conventional backplanes in EWoD devices, and such backplanes can be fabricated using amorphous silicon technology. The only components of the EWoD device which need to be modified to enable the present invention are the source driver (and possibly the gate driver, if a gate driver virtual ground is to be used, as described above with reference to FIG. 7), and the corresponding integrated circuits are normally already produced using a high grade silicon process. The modifications of the driver circuitry needed to enable the present invention are routine to those skilled in the integrated circuit art.

### CLAUSES

1. A digital microfluidic device, comprising:
   a first substrate comprising a plurality of first electrodes each having a transistor associated therewith, the first substrate further comprising a plurality of source lines, each source line being connected to a plurality of the first electrodes via their associated transistors, and a first dielectric layer covering the first electrodes and their associated transistors;
   a second substrate spaced from the first substrate and comprising at least one second electrode and a second dielectric layer covering the second electrode; and
   means for introducing a fluid between the first and second substrates and creating a microfluidic region between the first and second substrates,
   wherein at least one source line is provided with capacitance measuring means arranged to measure the capacitance between at least one of the first electrodes connected thereto and the at least one second electrode, and thereby determine the presence or absence of a fluid droplet between said at least one of the first electrodes and the at least one second electrode.
2. The digital microfluidic device of clause 1 further comprising means for applying an alternating voltage to the at least one second electrode.
3. The digital microfluidic device of clause 1 wherein the microfluidic region between the first and second substrates is filled with a first fluid and the fluid introduction means is arranged to introduce a second fluid immiscible with the first fluid.
4. The digital microfluidic device of clause 3 wherein the second fluid is aqueous and the first fluid is non-aqueous.
5. The digital microfluidic device of clause 4 wherein the first dielectric layer is hydrophobic or has a hydrophobic layer superposed thereon.
6. The digital microfluidic device of clause 4 wherein the second dielectric layer is hydrophobic or has a hydrophobic layer superposed thereon.
7. The digital microfluidic device of clause 2 wherein the capacitance measuring means comprises a capacitor connected to one source line and means for measuring the voltage drop across the capacitor.
8. A method of determining the presence or absence of a droplet adjacent a specific first electrode in a digital microfluidic device, the device comprising:
   a first substrate comprising a plurality of first electrodes each having a transistor associated therewith, the first substrate further comprising a plurality of source lines, each source line being connected to a plurality of the first electrodes via their associated transistors, and a first dielectric layer covering the first electrodes and their associated transistors;
   a second substrate spaced from the first substrate and comprising at least one second electrode and a second dielectric layer covering the second electrode; and
   means for introducing a fluid between the first and second substrates and creating a microfluidic region between the first and second substrates,
   the method comprising measuring the capacitance between said specific first electrode and the at least one second electrode.
9. The method of clause 8 wherein measurement of the capacitance is effected by applying an alternating voltage to the at least one second electrode, connecting a capacitor to said specific first electrode and measuring the voltage drop across the capacitor.
10. The method of clause 8 wherein the plurality of source lines are arranged parallel to one another and the method further comprises driving the two source lines closest to the source line connected to the specific first electrode at the same voltage as the source line connected to the specific first electrode.

1. A digital microfluidic device, comprising:
a first substrate comprising a plurality of first electrodes each having a transistor associated therewith, the first substrate further comprising a plurality of source lines, each source line being connected to a plurality of the first electrodes via their associated transistors, and a first dielectric layer covering the first electrodes and their associated transistors;
a second substrate spaced from the first substrate and comprising at least one second electrode and a second dielectric layer covering the second electrode; and
a microfluidic region between the first and second substrates,
wherein at least one source line is arranged to measure the capacitance between at least one of the first electrodes connected thereto and the at least one second electrode, and thereby determine the presence or absence of a fluid droplet between said first electrodes and the at least one second electrode.

2. The digital microfluidic device according to claim 1, wherein an alternating voltage is applied to the at least one second electrode.

3. The digital microfluidic device according to claim 1 or claim 2 wherein each first electrode is attached to a capacitor via the transistor.

4. The digital microfluidic device according to any one of claims 1 to 3, wherein the microfluidic region between the first and second substrates is filled with a first fluid and contains droplets of a second fluid immiscible with the first fluid.

5. The digital microfluidic device according to any one of claims 1 to 4, wherein the second fluid is aqueous and the first fluid is non-aqueous.

6. The digital microfluidic device according to any one of claims 1 to 5, wherein the first dielectric layer is hydrophobic or has a hydrophobic layer superposed thereon.

7. The digital microfluidic device according to any one of claims 1 to 6, wherein the second dielectric layer is hydrophobic or has a hydrophobic layer superposed thereon.

8. The digital micro fluidic device according to any one of claims 1 to 7 comprising a capacitor connected to the source line.

9. A method of determining the presence or absence of a droplet adjacent a specific first electrode in a digital microfluidic device, the device comprising:
a first substrate comprising a plurality of first electrodes each having a transistor associated therewith, the first substrate further comprising a plurality of source lines, each source line being connected to a plurality of the first electrodes via their associated transistors, and a first dielectric layer covering the first electrodes and their associated transistors;
a second substrate spaced from the first substrate and comprising at least one second electrode and a second dielectric layer covering the second electrode; and
a microfluidic region between the first and second substrates,
the method comprising measuring the capacitance between said specific first electrode and the at least one second electrode.

10. The method according to claim 9, wherein measurement of the capacitance is effected by applying an alternating voltage to the at least one second electrode, connecting a capacitor to said specific first electrode and measuring the voltage drop across the capacitor.

11. The method according to claim 9 or claim 10, wherein the plurality of source lines are arranged parallel to one another and the method further comprises driving the two source lines closest to the source line connected to the specific first electrode at the same voltage as the source line connected to the specific first electrode.

12. The method according to any one of claims 9 to 11, wherein the microfluidic region between the first and second substrates is filled with a first fluid and contains droplets of a second fluid immiscible with the first fluid.

13. The method according to claim 12, wherein the second fluid is aqueous and the first fluid is non-aqueous.

14. The method according to any one of claims 9 to 13, wherein the first dielectric layer is hydrophobic or has a hydrophobic layer superposed thereon.

15. The method according to any one of claims 9 to 14, wherein the second dielectric layer is hydrophobic or has a hydrophobic layer superposed thereon.
